(19) United States
(12) Patent Application Publication
(10) Pub. No.: US 2008/0047669 A1
(43) Pub. Date: Feb. 28, 2008

(54) DEHUMIDIFYING DEVICE FOR DOUBLE-FACED CORRUGATED PAPERBOARD

(76) Inventor: Kuan-Shiung Wu, Taoyuan County (TW)

Correspondence Address: LEONG C LEI, PMB # 1008, 1867 YGNACIO VALLEY ROAD, WALNUT CREEK, CA, 94598, US

(21) Appl. No.: 11/469,879

(22) Filed: Sep. 4, 2006

(30) Foreign Application Priority Data
Aug. 7, 2006 (TW) 095213797

(51) Int. Cl. B30B 15/34

(52) U.S. Cl. 156/583.1

(57) ABSTRACT

The dehumidifying device contains a dehumidifying space, a duct member within the dehumidifying space, and a number of second hot places beneath the duct member with appropriate gaps therebetween. When a paperboard passes through the dehumidifying space between the duct member and the second hot plates, air is introduced to the duct member and, because of the provision of the gaps, turbulence within the duct member is prevented and uniform air pressure is developed within the dehumidifying space, thereby pressing the paperboard against the second hot plates for continuous heating. In the mean time, the steam absorbed during previous stage of beating can be expelled along with the air flow.

### BACKGROUND OF THE INVENTION

(a) Technical Field of the Invention

The present invention generally relates to devices for manufacturing corrugated paperboards, and more particularly to a dehumidifying device for reducing water content of double-faced corrugated paperboards during their adhering process

(b) Description of the Prior Art

FIG. 1 is a schematic diagram showing a conventional manufacturing system for doable-faced corrugated paperboards. As illustrated, after a single-faced corrugated paperboard 140 is fed through a first preheat roll 130, adhesive is applied to the corrugated side of the paperboard 140 by a first glue roll 132 which is driven by a first wiper roll 131. Similarly, another single-faced corrugated paperboard 141 is fed through a second preheat roll 133 and then adhesive is applied to the corrugated side of the paperboard 141 by a second glue roll 135 which is driven by a second wiper roll 134. The paperboards 140 and 141 are together fed through a platform 50 along with a liner 142 that first goes through a third preheat roll 136 and a preheat tub 137. In the platform 50, the paperboards 140, 141, and the liner 142 are advanced over a number of hot plates 152 so that the paperboards 140, 141, and the liner 142 are adhered into a double-faced corrugated paper-board 30. The advancement of the paperboards 140, 141, and the liner 142 is achieved by the friction exerted by a first cotton-weaved belt 150 running around a first from belt roll 151, a number of guiding rolls 154, 155, 156, and a first back belt roll 158. The tension of the first, belt 150 is adjustable by a first adjustment, device 157 while a number of hold-down mils 153 or weight plates exert, force on the paperboards 140, 141, and the liner 142 so as to expedite their adhesion. At last, accompanied with the advancement provided by the first cotton-weaved belt 150, a second cotton-weaved belt 160 running around a second front belt roll 161, a second adjustment device 162, a guiding roll 163, and a second back belt roll 164 delivers the completed double-faced corrugated paperboard 30 out of the platform 50.

With the foregoing platform 50, the paperboards 140, 141, and the liner 142, as they advance, are pressed against the hot plates 152 by the first cotton-weaved belt 150 and the hold-down rolls 153 or weight plates over the belt 150. In the mean time, the hot plates 152 continuously give offbeat and therefore some steam beneath the paperboards 140, 141, and the liner 142. Due to the confinement of the first cotton-weaved belt 150, at least a portion of the steam is absorbed by the paperboard 30. This extraneous amount of water contained in the paperboard 30 would usually cause the paperboard 30 to deform and deteriorate the adhesion among the paperboards 140, 141, and the liner 142.

### SUMMARY OF THE INVENTION

The primary purpose of the present invention is to provides a dehumidifying device for the adhesion of double-faced corrugated paperboards. A major object of the present, invention is, when the paperboard passes through the platform, to raise the first cotton-weaved belt above the paperboard so that the moisture absorbed during heating is allowed to evaporate.

Another object of the present invention is to apply aerodynamics in pressing the paperboard against the hot plates for continuous heating to maintain the adhesion of the paperboard even without, the first cotton-weaved belt weighing down the paperboard.

To achieve the foregoing objects, the dehumidifying device of the present invention contains a dehumidifying space, a duct member within the dehumidifying space, and a number of second hot having grooves and arranged in parallel rows with appropriate gaps between adjacent rows. The dehumidifying space is formed by a number of guiding rolls raising the first cotton-weaved belt so as to accommodate the duct member. When the paperboard passes through the dehumidifying space between the duct member and the second hot plates, air is introduced to the duct member and, because of the provision of the gaps and grooves, turbulence within the duct member is prevented and uniform air pressure is developed within the dehumidifying space, thereby pressing the paperboard against the second hot plates for continuous healing. In the mean time, the steam can be expelled along with the air flow. A double-faced corrugated paperboard of significantly lower water content is therefore obtained.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which, a preferred structural embodiment incorporating the principles of the present invention is shown by way of illustrative example.

### BRIEF DESCRIPTION OF THE DRAWINGS

FIG. 1 is a schematic diagram showing a conventional system for manufacturing double-faced corrugated paperboards.

FIG. 2 is a schematic diagram, showing a system for manufacturing double-faced corrugated paperboards according to a first embodiment of the present invention.

FIG. 3 is a sectional view showing the duct member of FIG. 2. FIG. 4 is a top view showing the arrangement of the second hot plates of FIG. 2.

FIG. 5 is a front view showing the duct member of FIG. 2.

FIG. 6 is a schematic diagram showing a system for manufacturing double-raced corrugated paperboards according to a second embodiment of the present invention.

FIG. 7 is a sectional view showing the duct member of FIG. 6.

FIG. 8 is a front view showing the duct member of FIG. 6.

FIG. 9 is a schematic diagram showing a system for manufacturing double-faced corrugated paperboards according to a third embodiment of the present invention.

FIG. 10 is a schematic diagram showing a system for manufacturing double-faced corrugated paperboards according to a fourth embodiment of the present invention.

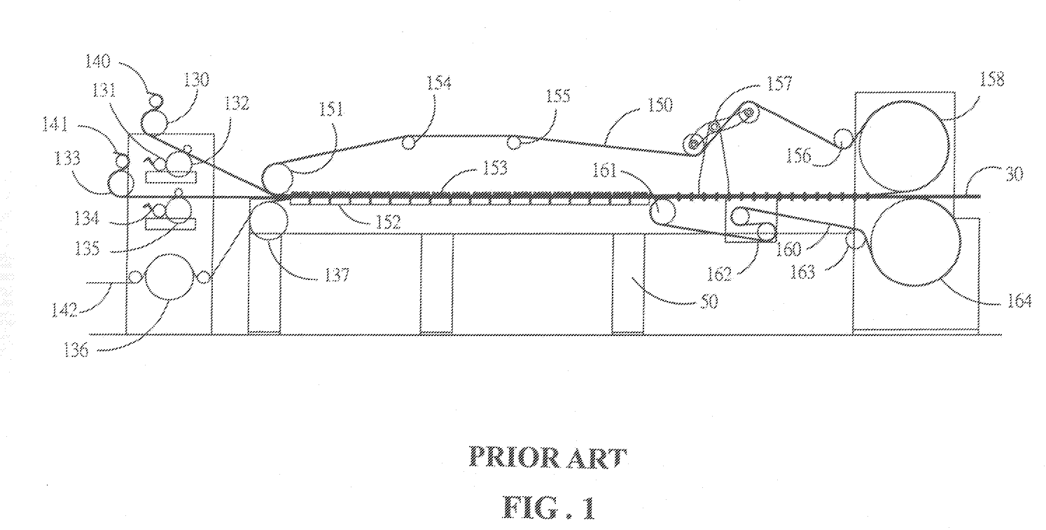

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration, for implementing exemplary embodiments of the invention. Various changes to the described embodiments may be made in the function and arrangement of the elements described without departing from the scope of the invention as set forth in the appended claims.

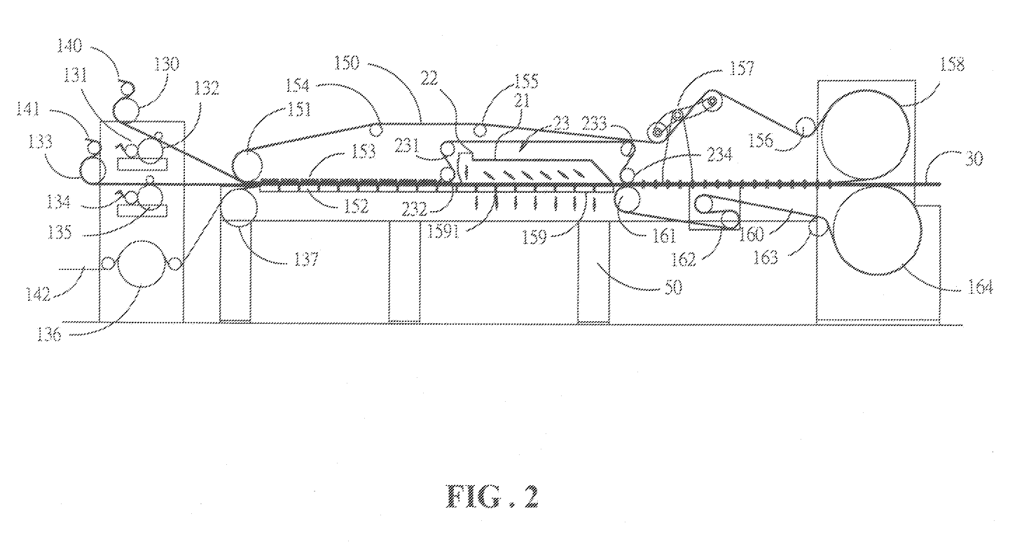

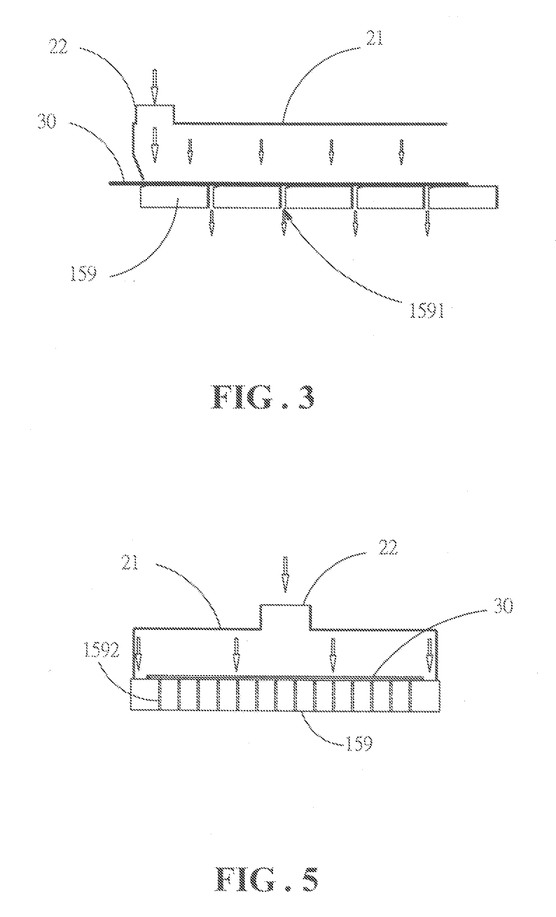

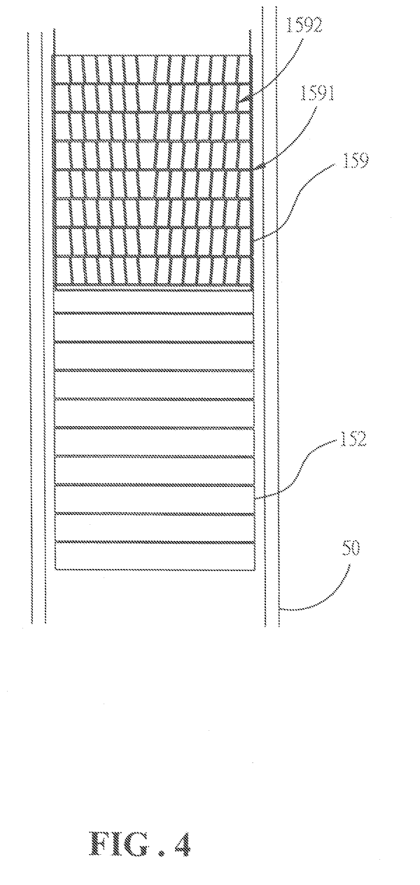

FIG. 2 is a schematic diagram showing a system for manufacturing double-faced corrugated paperboards according to a first embodiment of the present invention. As illustrated, the paperboards 140, 141, and the liner 142 are advanced over a number of hot plates 152 and then a number second hot plates 159. A number of guiding mils 231, 232, 233, and 234 are positioned so that the first cotton-weaved belt 150 is raised for an appropriate distance above the second hot plates 159, creating a dehumidifying space 23 for the moisture absorbed by the paperboard 30 during its travel through the hot plates 152 to evaporate. Please refer to FIG. 4 which is a top view showing the arrangement of the second hot plates 159. As illustrated, the second hot plates 159 are arranged into a number of parallel rows perpendicular to the direction of the advancement of the paperboard 30. An appropriate gap 1591 is preserved between every two adjacent rows and each second hot plate 159 has a number of appropriately spaced parallel grooves 1592 running aligned with the direction of the advancement of the paperboard 30. As shown in FIGS. 3 and 5, a duct member 21 is positioned within the dehumidifying space 23 above the second hot plates 159 and, when the paperboard 30 is advanced above the second plates 159, air is continuously introduced into the duct member 21. Because of the provision of the gaps 1591 and grooves 1592, turbulence is prevented and uniform air pressure is developed within the dehumidifying space 23, thereby pressing the paperboard 30 against the second hot plates 159 for continuous beating. In the mean time, foe steam can be expelled along with foe air flow. A double-faced corrugated paperboard of significantly lower water content is therefore obtained.

When the single-faced paperboards 140, 141, and the liner 142 are advanced by the first cotton-weaved belt 150 and pressed by the hold-down rolls 153 over and against the hot plates 152, they are adhered into the double-faced paperboard 30 which is continuously advanced into the dehumidifying space 23. Then, with the duct member 21 and the gaps 1591 and grooves 1592 as described above, the air flow removes rite extraneous water content from the paperboard 30 and the uniform pressure keeps the paperboard 30 flatly attached to the second hot plates 159 for continuous heating to maintain the adhesion among the paperboards 140, 141, and the liner 142. At last, accompanied with the advancement provided by the first cotton-weaved belt 150, the second cotton-weaved belt 160 running around the second from heft roll 161, foe second adjustment device 162, the guiding roll 163, and the second back, belt roll 164 delivers the completed double-faced corrugated paperboard 30 out of the platform 50. The paperboard 30 thus produced will not deform or bend from the surplus moisture and the adhesion among the paperboards 140, 141, and the liner 142 is much superior to that produced by foe conventional manufacturing system.

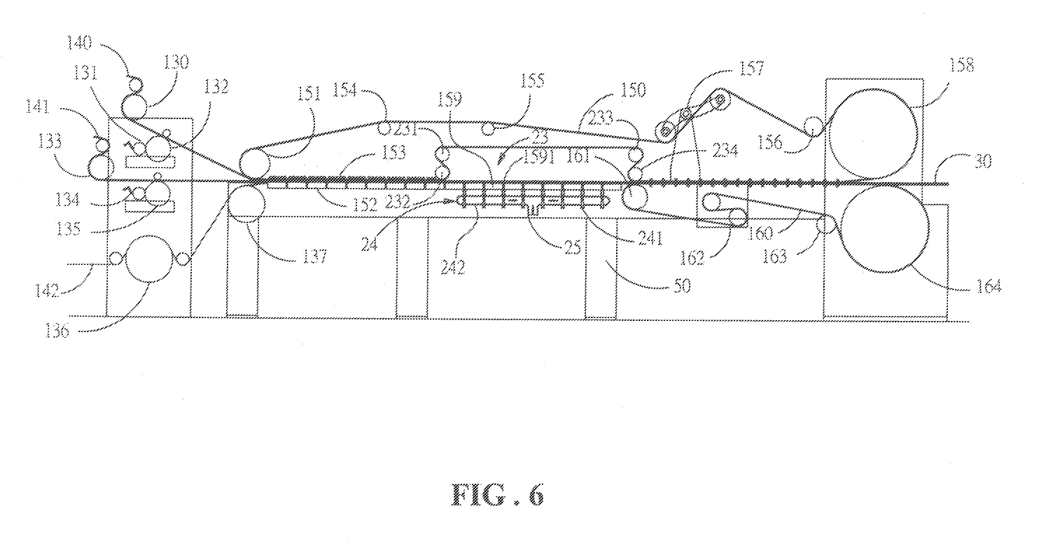

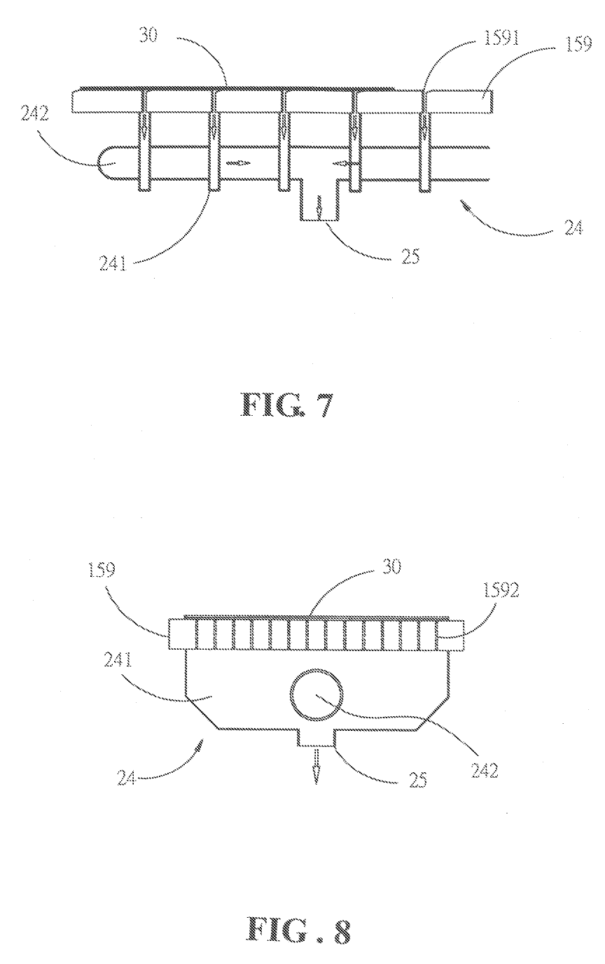

FIG. 6 is a schematic diagram showing a system for manufacturing double-faced corrugated paperboards according to a second embodiment of the present invention. This embodiment is similar to the previous one shown in FIG. 2 where a number of guiding rolls 231, 232, 233, and 234 are positioned so that the first cotton-weaved belt 150 is raised for an appropriate distance above a number of second hot plates 159 arranged in parallel rows behind the hot plates 152, creating a dehumidifying space 23 for the moisture absorbed by the paperboard 30 during its travel through the hot plates 152 to evaporate. The second hot plates 159 also have appropriate gaps 1591 therebetween and each second hot plate 159 has appropriately spaced grooves 1592 as in the previous embodiment. Then, as shown in FIGS. 7 and 8, a duct member 24 having a number fin-like channels 241 conducted through by a duct 242 with an outlet 25 is positioned beneath the second hot plates 159 such that each of the channels 241 has its opening aligned with a gap 1591. When air is drawn from the outlet 25 via the channels 241 and the gaps 1591, the paperboard 30 would be sucked towards and attached to the second hot plates 159. As such, the paperboard 30 is able to continue receiving heating from the second hot plates 159 while the moisture evaporates to the dehumidifying space 23.

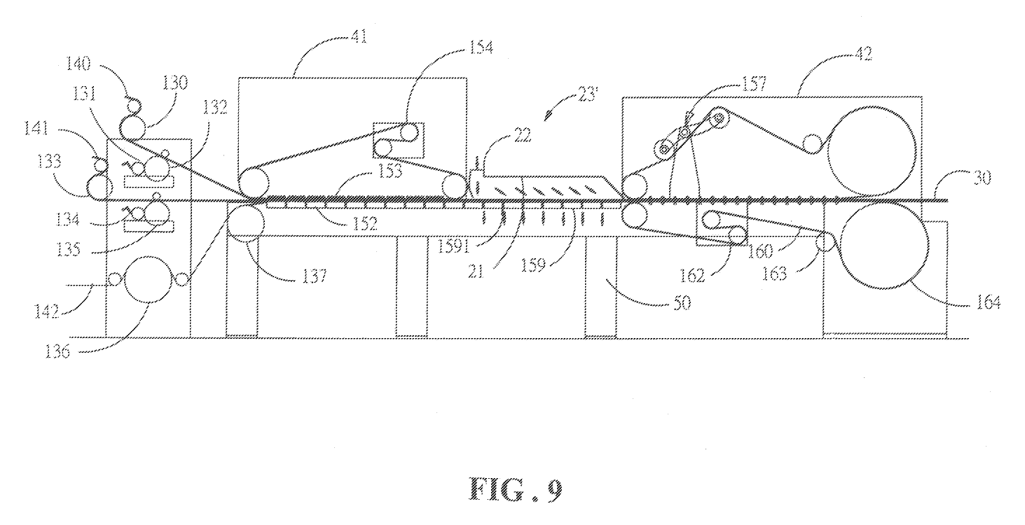

FIG. 9 is a schematic diagram showing a system for manufacturing double-faced corrugated paperboards according to a third embodiment of the present invention. As illustrated, the platform 50 contains two advancing mechanisms 41 and 42, leaving an open dehumidifying space 23′ therebetween. Similar to the previous embodiments, a duct member 21 is positioned within the dehumidifying space 23′ above the second hot plates 159. The paperboards 140, 141, and the liner 142, after being pre-heated and applied with adhesives, are drawn into the platform 50 by the advancing mechanism 41. When the paperboard 30 passes through the open dehumidifying space 23′, the moisture absorbed within the advancing mechanism 41 is allowed to evaporate. Also under the air pressure provided by the duct member 21, the paperboard 30 is pressed tightly against the second hot plates 159 for continuous heating. At last, accompanied with the advancement provided by the advancing mechanism 42, the second cotton-weaved belt 160 running around the second front belt roll 161, the second adjustment device 162, the guiding roll 163, and the second back belt roll 164 delivers the completed double-faced corrugated paperboard 30 out of the platform 50.

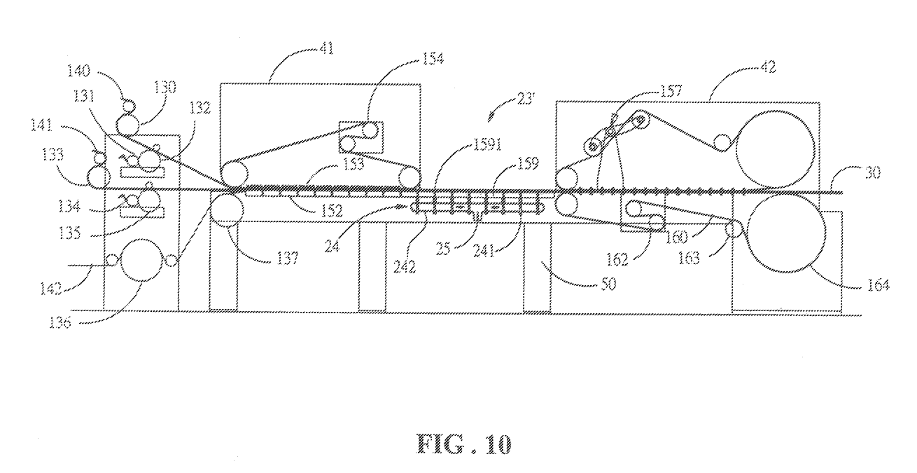

FIG. 10 is a schematic diagram showing a system for manufacturing double-faced corrugated paperboards according to a fourth embodiment of the present invention. Unlike the previous third embodiment, a duct member 24 having a number fin-like channels 241 conducted through by a duct 242 with an outlet 25 is positioned beneath the second hot plates 159 such that each of the channels 241 has its opening aligned with a gap 1591. When air is drawn from the outlet 25 via the channels 241 and the gaps 1591, the paperboard 30 is sucked towards and attached to the second hot plates 159. As such, the paperboard 30 is able to continue receiving heating from the second hot plates 159 while the moisture evaporates to the open dehumidifying space 232′. At last, accompanied with the advancement provided by tire advancing mechanism 42, the second cotton-weaved belt 160 running around foe second front belt roll 161, the second adjustment device 162, the guiding roil 163, and the second back belt roll 164 delivers the completed double-faced corrugated paperboard 30 out of the platform 50.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dehumidifying device in a platform for adhering a double-faced corrugated paperboard comprising:
a dehumidifying space;
a duct member within said dehumidifying space; and
a number of second hot plates;
wherein said paperboard is advanced through said dehumidifying space above said plurality hot plates.

2. The dehumidifying device according to claim 1, wherein said duct member is positioned above said paperboard; and air is introduced into said duct member to press said paperboard against said plurality of second hot plates.

3. The dehumidifying device according to claim 1, wherein a said second hot plate has a plurality of appropriately spaced grooves; and an appropriate gap is provided between two adjacent said second hot plates.

4. The dehumidifying device according to claim 3, wherein said duct member is positioned beneath said plurality of second hot plates; said duct member has a plurality of channels; a said channel is aligned with a said gap; and air is drawn from said duct member to suck said paperboard towards said plurality of second hot plates.

5. The dehumidifying device according to claim 1, wherein said dehumidifying space is formed by raising a cotton-weaved belt of said platform above said second hot plates.

6. A dehumidifying device in a platform for adhering a double-faced corrugated paperboard comprising:
an open dehumidifying space;
a plurality of advancing mechanisms;
a duct member within said dehumidifying space; and
a number of second hot plates;
wherein said dehumidifying space is positioned between said advancing mechanisms; said paperboard is advanced through said dehumidifying space by said advancing mechanisms above said plurality of second hotplates.

7. The dehumidifying device according to claim 6, wherein said duct member is positioned above said paperboard; and air is introduced into said duct member to press said paperboard against said plurality of second hot plates.

8. The dehumidifying device according to claim 6, wherein a said second hot plate has a plurality of appropriately spaced grooves; and an appropriate gap is provided between two adjacent said second hot plates.

9. The dehumidifying device according to claim 8, wherein said duct member is positioned beneath said plurality of second hot plates; said duct member has a plurality of channels; and a said channel is aligned with a said gap.

10. The dehumidifying device according to claim 9, wherein air is drawn from said duct member to suck said paperboard towards said plurality of second hot plates.
